(19) United States
(12) Patent Application Publication
(10) Pub. No.: US 2002/0064550 A1
(43) Pub. Date: May 30, 2002

(54) Edible candy compositions and methods of using same

(75) Inventors: Alan E. Kligerman, Egg Harbor Township, NJ (US); Sarah Finnegan, Mays Landing, NJ (US)

Correspondence Address: AKIN, GUMP, STRAUSS, HAUER & FELD, L.L.P., ONE COMMERCE SQUARE, 2005 MARKET STREET, SUITE 2200, PHILADELPHIA, PA, 19103, US

(73) Assignee: AkPharma, Inc., Pleasantville, NJ

(21) Appl. No.: 09/949,358

(22) Filed: Sep. 7, 2001

Related U.S. Application Data
(60) Provisional application No. 60/230,650, filed on Sep. 7, 2000.

(51) Int. Cl. A23G 3/00

(52) U.S. Cl. 424/440; 426/93; 426/73

(57) ABSTRACT

Candy food, a piece of confectionery, which is a small, hard, chewy, or soft piece of food made from sugar and other ingredients or flavorings, such as chocolate, nuts, fruit, or peppermint is provided with enhanced refreshing properties of deacidifying the mouth and a stomach from the food or drink just consumed as well as reducing mouth, throat, esophageal, or other gastrointestinal irritation, together with reducing the incidence of dental caries and delivering absorbable calcium and phosphorus, wherein said candy food comprises combining a candy component with an effective amount of calcium glycerophosphate.

### CROSS-REFERENCE TO RELATED APPLICATIONS

This application claims the benefit of U.S. Provisional Application No. 60/230,650 filed Sep. 7, 2000.

### BACKGROUND OF THE INVENTION

Candy is defined as a piece of confectionery which is a small hard, chewy, or soft piece of food made from sugar and other ingredients or flavorings such as chocolate, nuts, fruit, or peppermint. Candy may also be called confectionery in the United States and sweets in the United Kingdom. Soft, or crystalline, candy is smooth, creamy, and easily chewed. Typical soft candies are fondants (the basis of chocolate creams) and fudge. Typical hard, or noncrystalline candies include toffees and caramels. Other favorite candies include nougats, marshmallows, the various forms of chocolate (bars or molded pieces, sometimes filled), pastes and marzipan (based on crushed almonds or almond paste), cotton candy (spun sugar), popcorn, licorice, and chewing gum. Mint or other flavored candies, hard, soft or filled, chocolate covered or otherwise are very popular and widely enjoyed by many people as an after meal refreshment. Although not traditionally marketed as candies, cough drops and other medicated lozenges are a type of confection which contains sugar and other flavorings, such as fruit. “Confections” also describes foods such as cake and pastry icing, jellied pastry filling, ice cream, and all baked goods containing sugar, such as, but not limited to, cakes, cookies, buns, pastries, and ice cream cones.

Candies are usually high in sugar content, and therefore, known to cause dental caries in humans as well as in animals. While the high sugar content and high calorie content of candy foods, chocolate foods, beverages and confections (hereinafter collectively referred to as “candy foods”) have been known for some time, neither property of these candy foods has been much of a deterrent to their widespread consumption. However, there are people who experience some physical discomfort when consuming edible, chocolate foods, and thus, do not experience the same enjoyment as others when consuming these foods.

Some people report experiencing a slight “burn” in the back of their throats upon consumption of chocolate foods. Additionally, people with interstitial cystitis (IC), a disease of the urinary bladder in which the bladder cells are highly sensitive to acidic food intake, have experienced exacerbated symptoms of IC, when consuming chocolate foods. A study of two hundred patients with IC, by Bologna et al, Urology 57 -6A, June 2001, reports that 42% of those 200 people experienced heightened symptoms from consuming chocolate foods. A further study by Tu, et al, Quebec Urological Association, 2000, reports, in 200 reported patients, over-all reduction of symptoms of bladder irritants from 79.4% without calcium glycerophosphate (Prelie®) with foods to 14.6% when calcium glycerophosphate was taken with foods.

It is known that certain additives can be combined with other foods according to the dietary needs and/or desires of consumers. A wide spectrum of additives, such as, for example, flavor enhancers and digestion aids, have been combined with other foods for varying purposes. For example, it is known that monosodium glutamate (MSG) can be added to certain foods to enhance their flavor. It is also equally well known that lactase can be added to certain lactose-containing foods to accommodate the lactose intolerance of some individuals.

Recently, certain additives have been developed for reducing heartburn and other gastrointestinal distress in mammals due to ingestion of acidic foods and acidic beverages. U.S. Pat. Nos. 5,665,415 and 5,869,119 of Kligerman et al. describe methods of increasing the pH of acidic foods and reducing distress in mammals after the consumption of acidic foods by combining the food with calcium glycerophosphate. Both patents discuss the use of the methods with respect to acidic foods and beverages such as coffee, beer, fruit juice, tomato juice, lemonade, soft drinks, wine, sherbets, pizza, pickles, salsa, sauerkraut, spaghetti with tomato sauce and other dishes containing tomato products, as well as acidic medicaments. As described in the patents, the combination or ingestion of calcium glycerophosphate and the acidic food reduces the acidity of the foods and is thought to alleviate the sharp bite felt in the mouths of consumers who have acid sensitivities.

While candy foods can be highly acidic, chocolate foods are generally not very acidic. In fact, under the U.S. Food & Drug Administration's criterion for “acidic foods” (pH ≲4.6), most chocolate foods would not be considered “acidic foods.” For example, the pH of a Hershey's® dark chocolate bar, in liquid form (molten), has been measured at approximately 5.5. Yet, as popular as chocolate foods are with most of the population, some people still experience varying discomfort and/or distaste when consuming such items, and therefore, may not enjoy chocolate foods as many people do.

Thus, there exists a need in the art for candy foods which are enjoyable by more of the population and which do not exhibit any undesirable tastes and/or flavors, nor cause any undesirable effects in the mouth and/or digestive tracts of consumers.

### BRIEF SUMMARY OF THE INVENTION

The present invention includes a composition for human consumption comprising a candy component and calcium glycerophosphate (CGP). The edible compositions in accordance with the present invention reduce the incidence of dental caries, confer absorbable calcium and phosphorus onto the tooth enamel as well as lessen irritation of the mouth and deacidify the plaque and the mouth, and further act as a slight antacid in the stomach. Particularly, in case of chocolate covered candies, the filling containing CGP enhances the chocolate flavor without the undesirable burn or throat irritation experienced by some people when consuming prior art compositions containing chocolate.

The present invention also includes a method of dental caries reduction by consumption of an edible, candy food, wherein said candy food has enhanced refreshing properties of deacidifying a consumer's mouth and the stomach from the food or drink just consumed, and delivering absorbable calcium and phosphorus onto the tooth enamel, and wherein said method comprises combining a candy component with an effective amount of calcium glycerophosphate.

The present invention also includes a method of reducing mouth, throat or esophageal irritation accompanying consumption of a candy food, said method comprising combining a candy component with an amount of CGP sufficient to reduce irritation prior to ingestion of the candy food.

### DETAILED DESCRIPTION OF THE INVENTION

As indicated above, the invention is directed to edible candy compositions comprising a candy component and calcium glycerophosphate (CGP) wherein the resulting candy food may be, for example, a chocolate-covered candy. As used herein, “candy component” refers to a piece of confectionery which is a small hard, chewy, or soft piece of food made from sugar and other ingredients or flavorings such as chocolate, nuts, fruit, or peppermint as previously described.

CGP is also known as 1,2,3-propanetriol, mono(dihydrogen phosphate) calcium salt (1:1), calcium glycerinophosphate, calcium phosphoglycerate and Neurosin®. It has a molecular formula of C₃H₇CaO₆P and a formula weight of 210.14 (anhydrous). It may exist as a hydrate, including the monohydrate and the dihydrate. Three CGP isomers exist, namely β-glycerophosphoric acid calcium salt ((HOCH₂)₂CHOPO₃Ca and D(+)- and L(-)-α-glycerophosphoric acid calcium salt (HOCH₂CH(OH)CH₂OPO₃Ca). Any one isomer, or any combination of two or more isomers may be used as the CGP according to the invention. A commercially available form of CGP is a mixture of calcium β- and DL-α-glycerophosphates, and this is a preferred CGP according to the invention. The preferred form of CGP is food grade CGP according to Foods Chemical Codex (FCC) III, and may be obtained from Gallard Schlesinger Company, Carl Place, N.Y. 11514, which is a distributor for the Dr. Paul Lohmann GmbH KG of Emmerthal, Germany; Seppic (France); or Astha (India), among others.

There have been studies that confirm dental caries reduction in the sugar-content diets of animals when calcium glycerophosphate (CGP) was utilized (see W. H. Bowen, The Cariostatic Effect of Calcium Glycerophosphate in Monkeys, Caries Res. 6:43-51 (1972); T. H. Orenby, Comparison of the Cariostatic Effects of Calcium and Sodium Glycerophosphates in Rats, Helv. Odont. Acta 17:54-55 (October 1973); Pianotti, R. S., et al., Cariostafic Activity of Calcium Glycerophosphate in Hamsters; Topical vs. Dietary Administration, J. Dent Res., November-(December 1976); W. H. Bowen, The Monitoring of Acid Production in Dental Plaque in Monkeys, Brit. Dental J. 506 (1969)), as well as other studies that fail to confirm same in human children (see Brook, A. H., et al, Calcium Glycerophosphate and Dental Plaque, Caries Res. 9: 156-162 (1975)). Applicants believe that properly conducted and controlled human diets will ultimately confirm the same results in humans as in animals.

CGP is odorless, almost tasteless, and forms a fine, slightly hygroscopic powder. CGP may also be formed into tablets, and may be dissolved into water. The solubility of CGP is about 1 gram in about 50 mL of water. FCC III lists CGP as a nutrient/dietary supplement, but does not indicate that CGP is either an alkali or a buffer/neutralizing agent. Thus, CGP is known in the art to be useful as a dietary supplement for calcium and phosphate, where CGP contains 19 wt % calcium.

The CGP may be used alone or in combination with other calcium salts, such as calcium carbonate, calcium acetate, calcium oxide, calcium hydroxide, calcium phosphate, calcium lactate and calcium citrate. As CGP is relatively expensive, combining CGP with a calcium salt such as listed above affords a less expensive composition for enhancing the flavor of chocolate foods. However, the combination of CGP and one or more additional calcium salts may have solubility properties that are very different from that of CGP alone. Thus, if CGP will be combined with other calcium salts or compounds, the solubility and stability of the combination in the chocolate food of interest should be checked.

Edible candy compositions in accordance with the present invention can contain calcium glycerophosphate in an amount sufficient to neutralize at least two-thirds of any acid present in the candy component(s), and preferably at least three-fourths of any acid present in the chocolate component(s). Generally, the edible compositions in accordance with this invention can contain calcium glycerophosphate present in an amount sufficient to raise the pH of the composition to a level equal to or greater than about 5.7, preferably to a level equal to or greater than about 6.0, more preferably to a level equal to or greater than about 6.2, and most preferably to a level equal to or greater than about 7.4. The amount of calcium glycerophosphate in edible candy compositions is preferably present from 0.05% by weight to 5% by weight or more, based on the weight of the candy component, more preferably 1% by weight to 4% by weight, and most preferably 2% by weight to 3.5% by weight.

One embodiment of the present invention relates to chewy candies containing CGP which preferably contain less than about 4.95% of gum content. Chewy candies may be enjoyed in two ways. Some people prefer to keep a chewy candy in their mouth for a long time as it slowly dissolves and is swallowed. Other people prefer to chew the candy into discrete fractions with their teeth, thereby rendering it swallowable either by mastication with the teeth or by dissolution by the saliva in the mouth. In either case, chewy candies tend to stick to the teeth and, as a result, the sugar remains on and between the teeth and causes dental caries. The presence of the CGP in such chewy candy will reduce the incidence of dental caries that would be expected from consumption of such candies, and further will provide the body with a source of calcium.

An additional embodiment of the present invention involves cough drops. Cough drops are medications which are utilized to reduce throat irritation and particular throat epithelial cell vulnerability to irritating food and beverages such as, for example, coffee and spices. The inclusion of CGP in cough drops will be advantageous to reduce the incidence of dental caries resulting from the use of cough drops, which typically contain sugar, and also to provide the added benefit of calcium. Further, by reducing the acidity in the mouth and throat, the CGP will serve to enhance the performance of the cough drops by mitigating the aggravating effects of irritating foods and beverages if such irritation is a result of the acidity in the food.

Another embodiment of this invention includes confections which are enhanced with CGP. These confections may include, for example, cake and pastry icing, jellied pastry filling, ice cream, and baked goods such as cakes, buns, pastries, cookies, and ice cream cones. The presence of the CGP in such foods would make them especially attractive to parents who often worry that the consumption of high-sugar foods will result in dental caries in their children. Rather, by ingesting the CGP-enhanced confections, the incidence of dental caries would be reduced due to deacidificatin of the mouth, deacidification of the plaque, and insertion of calcium and phosphorus into the plaque.

One of the preferred embodiments of the present invention is the addition of CGP to York® brand mints by Hershey Chocolate Company. York® brand mints are popular after meal refreshment, which has high sugar content. These mints are coated with a sweet or semi-sweet chocolate and have a soft white center. The present invention intends that the candy enhanced by CGP continue to maintain the normal refreshing taste.

In the preferred embodiment, the mint and chocolate combination help to mask CGP's normal chalky taste and texture when CGP is added to the mint filling. Furthermore, the CGP shows an unexpected textural affinity for a creamy mint center, which allows the CGP to ‘disappear’. The objectives of choosing the York® brand mints were as follows:

1. There would be the normal refreshing taste of the CGP enhanced mint, as originally intended.

2. The CGP enhanced mint would deacidify the mouth from the meal or drink just consumed.

3. The CGP enhanced mint would confer topically absorbable calcium and phosphorus onto the tooth enamel.

4. The CGP enhanced mint would confer calcium and phosphorus into the plaque.

5. The CGP enhanced mint would deacidify the plaque.

6. The CGP enhanced mint would confer a deacidified state in the mouth that would last from several minutes to a few hours.

7. The CGP enhanced mint would reduce the incidence of dental caries induction that could be expected from both the meal just consumed as well as from the sugar-content mint that followed it.

8. The CGP enhanced mint would cool the back of the mouth as well as the throat, when swallowed, because of the antacid capability of CGP.

9. The CGP enhanced mint would behave as a slight antacid in the stomach, because of the CGP.

10. The CGP in the CGP enhanced mint would metabolize in the body as calcium and phosphorus at a 1:1 molar ratio.

11. The CGP in the CGP enhanced mint would permit ingestion by persons on low-acid diets for a number of reasons not related to heartburn or gastro-esophageal reflux; among these reasons would be a variety of urinary and/or bowel irritation problems, as well as dermatological and epithelial cell ulceration problems attributable to dietary acid.

12. The CGP in the CGP enhanced mint would deacidify the mouth after smoking or chewing tobacco.

The method of combining of the effective amount of CGP with the candy component may be performed in any suitable manner, wherein the two ingredients are either mixed together or CGP is spread along the center of the candy component, for example.

The present invention includes a method of dental caries reduction by consumption of an edible, candy food, wherein the candy food comprises combining a candy filling component with an amount of CGP. The candy food would reduce the incidence of dental caries induction that could be expected from both the meal just consumed as well as from the sugar content of the candy that followed it. Further, the candy food delivers absorbable calcium and phosphorus onto the tooth enamel and maintains the normal refreshing taste of the mint, as originally intended. CGP in the candy would metabolize in the body as calcium and phosphorus at a 1:1 molar ratio.

The present invention also includes a method of protection from acid-deleterious effects of consumed meal or drink comprising a consumption of a candy food wherein the candy food comprises a CGP component that enhances refreshing properties of the candy food by deacidifying a consumer's mouth and stomach from the food or drink just consumed. Consequently, the mint as disclosed in the preferred embodiment, or other candy food containing CGP in accordance with the present invention, would cool the back of the mouth as well as the throat, when swallowed, because of the antacid capability of CGP (See Kligerman et al. U.S. Pat. No. 5,665,415). Also, the mint containing CGP would behave as a slight antacid in the stomach (See Kligerman et al. U.S. Pat. No. 5,869,119).

The present invention further includes a method of reducing irritation in the mouth, throat, or esophagus of chocolate consumers, comprising consumption of a chocolate covered candy containing CGP prior to ingestion. When CGP is added to chocolate containing candy foods made in accordance with the present invention, such candy foods exhibit a strong and enhanced flavor, smoothness, mellowness and depth, without any bum associated with chocolate. As used herein, “burn” refers to any irritation and/or unpleasant taste that may be felt in the back of the throat or the roof of the mouth or upon swallowing by a person consuming chocolate. CGP may be combined with candy filling components using the methods and in the amounts described above. This is possibly the first truly functional after-meal mint, considering its simultaneous refreshing of the mouth, removal or beneficial modification of adverse meal residue in the mouth, and the several further physiological benefits named.

The invention will now be described in more detail with respect to the following non-limiting examples:

### EXAMPLE 1

CGP was combined with the soft creamy mint filling of York® brand mints made by Hershey Chocolate Company at the ratio of 0.33 g CGP per 11.75-12 g mint. The York mints were chosen for the above experiment because (1) such candy is very high in sugar, (2) the mint and chocolate combination may help mask CGP's normal chalky taste and texture, and (3) the York mints are classic ‘after meal’ candies. The soft white center of these mints is coated with a sweet or semi-sweet chocolate. The mints are 1½″ in diameter and about ⅜″ thick. A single mint weighs about 11.75 to 12 grams. In a typical mint, the total weight was 11.7809 g with the mint center weighing 8.7983 g, or approximately 75% of the total weight. The CGP/total candy weight was, in this case, about 2.8%, and the CGP/mint-center weight was about 3.8%. Each such mint is individually over-wrapped with a paper-foil material.

The York mints were split laterally along the flat axis, by standing them on end and slicing with the wire of a butter patty cutter. Each sliced mint fell neatly in two, and the CGP was added and evened out along the surface of one side of the mint using a small laboratory spatula. The mint halves were then promptly re-fit, lightly patted together and re-wrapped in the original foil-paper wrapping. Selected mints, with and without addition of CGP were carefully separated from their chocolate coating, thoroughly mashed and mixed and subjected to pH readings according to United States Pharmacopoeia (USP) procedures. The pH of the untreated mints was 6.0 and that of the CGP-added mints was 7.4. The pH rise was in accordance with expectations of CGP properties.

Sample mints were eaten immediately for taste purposes. Surprisingly, CGP was almost entirely subsumed into the mint center and was barely detectable. Such a “perfect marriage” of CGP and soft mint was unexpected. Mints were also sampled the following day and the CGP was even less detectable. One reason for this “disappearance” of the CGP is by virtue of the inherently slightly oily-granular quality of a creamy mint center along with the strong mint flavor. It was projected that under normal candy manufacturing procedures, wherein the CGP would be added to the mint mixture at the time of initial mixing with an aliquot blend achieved, that for all intents and purposes, as far as taste, appearance and mouthfeel are concerned, there would be no detectable difference in such mint with CGP added vs. the original mint.

### EXAMPLE 2

CGP was combined with the soft creamy mint filling of York® brand mints made by Hershey Chocolate Company as described in the Example 1 above. However, after the York mints were split laterally along the flat axis with a butter patty cutter, 2 or 3 drops of water per mint were added to the dry CGP powder, prior to the closing of the mint halves. This proved to be a most desirable procedure, rendering CGP totally indistinguishable from the rest of the mint, and immediately so. In actual commercial manufacture, at the time CGP would be added, water would also be added to the viscous mint mixture in an amount appropriate to maintain desirable moisture content and material plasticity of the blend as a whole.

### EXAMPLE 3

In a small candy manufacturing plant with availability of a gas-heated, water-jacketed kettle, five separate batches of cream fondant base were made over a period of three months. They were coated with chocolate, which itself had been mixed with CGP. The procedure and ingredient ranges of the batches were as follows:

| | Concentration Range of |
|---|---|
| Ingredient | Solid/Liquid Ingredient |
| Amerfont (Domino brand 100% Sucrose) | 89.9%-91.6% |
| Fondex (White Stokes brand corn syrup | 5.62%-5.73% |
| sugar mixture) | |
| Supervert ® (Invertase) | 0.22%-0.23% |
| Peppermint (Otten's Quaker ® brand | 0.22%-0.23% |
| twice rectified) | |
| Calcium glycerophosphate (Astha | 3.61%-4.05% |
| Company) | |
| Water | 74.3 mls per pound of fondant |
| | 100% Total |

### PROCEDURE

Into a double boiler add the Amerfont and the Fondex, adding enough water to liquefy just enough to make a viscous, yet easily flowable product. Heat mixture to a point within the range of 115° F. -150° F. while stirring. Add the calcium glycerophosphate slowly, mixing thoroughly to verify equal distribution throughout the product. Add the peppermint flavor last in order to minimize flavor loss through prolonged heating. Remove from heat and dispense, via hand-dipping or mechanical depositor, into patties of the desired size onto a paper-covered receiving tray. Set aside for textural curing and ‘setting up’ of patties.

Take the previously weighed or otherwise measured amount of chocolate and add it to the previously cleaned chocolate-holding well of the chocolate-coating machine; liquefy via adjustment of heat in the well and add 1% calcium glycerophosphate directly to the now liquid chocolate. Verify thorough mixing to obtain aliquot delivery. Take the now set up fondant patties and put them through the chocolate coating machine. Shake off excess chocolate via vibratory mechanism so that the final mint comprises 10% to 50% of the chocolate, depending on the thickness of coating desired, and so that the fondant comprises 50% to 90% of the final mint. The chocolate coated mint is then conveyed via a belt mechanism through a cooling-tempering tunnel which ‘sets’ the final product in such manner to assure that the chocolate coating will display no defects, such as ‘bloom’, a visual and textural defect well-known in the trade.

The average final mint weighs from 10 grams to 16 grams, comprising 2.48 % to 3.7% calcium glycerophosphate, calculated as a percentage of the entire product, fondant and chocolate covering.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A candy food composition for human consumption, comprising a candy component and calcium glycerophosphate.

2. The composition according to claim 1, wherein the calcium glycerophosphate is present in said candy food in an amount effective to reduce the induction of dental caries.

3. The composition according to claim 1, wherein the calcium glycerophosphate is present in said candy food in an amount effective to deliver absorbable calcium and phosphorus onto a consumer's tooth enamel.

4. The composition according to claim 1, wherein said candy food has enhanced refreshing properties of deacidifying a consumer's mouth and stomach from food or drink just consumed.

5. The composition according to claim 1, wherein the calcium glycerophosphate is present in an amount of about 0.05% by weight to 5% by weight, based on the weight of the candy component.

6. The composition according to claim 1, wherein the calcium glycerophosphate is present in an amount sufficient to raise the pH of the composition to a level of at least about 5.7.

7. The composition according to claim 1, wherein the candy component comprises a soft minty substance.

8. The composition according to claim 1, wherein the candy component is covered with a sweet or semi-sweet chocolate.

9. The composition according to claim 1, wherein the calcium glycerophosphate is present in said candy food in an amount effective to enter into the tooth-gum interproximal spaces, pockets, or plaque to neutralize acids in those locations.

10. The composition according to claim 1, wherein the candy food is a chewy candy and wherein the candy component comprises less than about 4.95% of a gum content.

11. The composition according to claim 1, wherein the candy food is a cough drop or other medicated lozenge.

12. The composition according to claim 1, wherein the candy food is cake or pastry icing.

13. The composition according to claim 1, wherein the candy food is ice cream.

14. The composition according to claim 1, wherein the candy food is jellied pastry filling.

15. The composition according to claim 1, wherein the candy food is a sugar-content baked good selected from the group consisting of a cake, a cookie, a bun, a pastry and an ice cream cone.

16. A method for reducing dental caries reduction by consumption of an edible, candy food composition, wherein said method comprises combining a candy component with an amount of calcium glycerophosphate sufficient to raise the pH of the composition to a level of at least about 5.7.

17. The method according to claim 16, wherein calcium glycerophosphate is combined with the candy component in the amount of about 0.05% by weight to 5% by weight, based on the weight of the candy component.

18. The method according to claim 16, wherein the calcium glycerophosphate is present in an amount sufficient to raise the pH of the composition to a level of at least about 7.4.

19. The method according to claim 16, wherein the candy component comprises a soft minty substance.

20. The method according to claim 16, wherein the candy component is covered with a sweet or semi-sweet chocolate.

21. The method according to claim 16, wherein the calcium glycerophosphate enters into the tooth-gum interproximal spaces, pockets, or plaque to neutralize acids in those locations.

22. The method according to claim 16, wherein the candy food is a chewy candy and wherein the candy component comprises less than about 4.95% of a gum content.

23. The method according to claim 16, wherein the candy food is a cough drop or other medicated lozenge.

24. The method according to claim 16, wherein the candy food is cake or pastry icing.

25. The method according to claim 16, wherein the candy food is ice cream.

26. The method according to claim 16, wherein the candy food is jellied pastry filling.

27. The method according to claim 16, wherein the candy food is a sugar-content baked good selected from the group consisting of a cake, a cookie, a bun, a pastry and an ice cream cone.

28. A method of reducing mouth, throat or esophageal irritation accompanying consumption of a chocolate covered candy food, said method comprising combining a chocolate food component with an amount of calcium glycerophosphate sufficient to reduce irritation prior to ingestion of the chocolate food.

29. The method according to claim 28, wherein the amount of calcium glycerophosphate combined with the chocolate food component is about 0.05% by weight to 5% by weight, based on the weight of the chocolate food component.

30. The method according to claim 28, wherein the calcium glycerophosphate is present in an amount sufficient to raise the pH of the chocolate food component to a level of at least about 5.7.

31. The method according to claim 28, wherein the chocolate food component comprises sweet or semi-sweet chocolate.

32. A method of protection from acid-deleterious effects of consumed meal or drink comprising consumption of a candy food according to claim 1, wherein said candy food has enhanced refreshing properties of deacidifying a consumer's mouth and stomach from the food or drink just consumed.
